(19) United States
(12) Patent Application Publication
(10) Pub. No.: US 2026/0119271 A1
(43) Pub. Date: Apr. 30, 2026

(54) DYNAMIC DATA CENTER WORKLOAD DEPLOYMENT

(71) Applicant: Dropbox, Inc., San Francisco, CA (US)

(72) Inventors: Miron Veryanskiy, Seattle, WA (US); Eric Shobe, Kihei, HI (US)

(73) Assignee: Dropbox, Inc., San Francisco, CA (US)

(21) Appl. No.: 18/931,607

(22) Filed: Oct. 30, 2024

(51) Int. Cl. G06F 9/50

(52) U.S. Cl. CPC G06F 9/5083

(57) ABSTRACT

Systems or methods are disclosed for dynamically allocating workloads to the most suitable resources within a data center, considering the transient nature of both workload requirements and available resources. The dynamic allocation of workloads may be achieved by testing servers with synthetic workloads and deploying full workloads to the servers or the servers most similar to those that handled the test well. This approach yields more efficient deployment than simply assigning workloads to the first available server.

### BACKGROUND

The hardware available in a data center is not stable over time. Hardware can become unavailable in a data center to execute workloads due to various reasons including maintenance, component servicing, end-of-life deprecation, component upstream failures, new hardware introductions, or financially driven operating requirements. Similarly, workload shapes in a data center are also ever evolving and transient. In a data center, different hardware configurations might excel at different styles of workloads.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A, FIG. 1B, and FIG. 1C illustrate an example environment for selecting a server for executing one or more workloads based on how a server executed a synthetic workload in accordance with some aspects of the present technology.

FIG. 2A illustrates an example environment for selecting a server for executing one or more workloads based on how a server executed a synthetic workload in accordance with some aspects of the present technology.

FIG. 2B illustrates the example environment of FIG. 2A for selecting a server for executing one or more workloads based on how a server executed a synthetic workload in accordance with some aspects of the present technology.

FIG. 2C illustrates the example environment of FIG. 2A for selecting a server for executing one or more workloads based on how a server executed a synthetic workload in FIG. 2B in accordance with some aspects of the present technology.

FIG. 2D illustrates the example environment of FIG. 2A for selecting a server for executing one or more workloads based on how a server executed a synthetic workload in FIG. 2C in accordance with some aspects of the present technology.

FIG. 2E illustrates the example environment of FIG. 2A for selecting a server for executing one or more workloads based on how a server executed a synthetic workload in FIG. 2D in accordance with some aspects of the present technology.

FIG. 3 illustrates an example method for publishing a suggestion for a selected server to be an executor of a workload associated with a synthetic workload based on workload performance profiles in accordance with some aspects of the present technology.

FIG. 4 illustrates a first example method for selecting a server for executing one or more workloads based on how a server executed a synthetic workload in accordance with some aspects of the present technology.

FIG. 5 illustrates a second example method for selecting a server for executing one or more workloads based on how a server executed a synthetic workload in accordance with some aspects of the present technology.

FIG. 6 illustrates an example of computing system in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The present technology addresses, among other things, the various deficiencies discussed above by providing a system that dynamically allocates workloads to suitable resources within a data center, taking into account the transient nature of both workload requirements and available resources. The present technology may achieve the dynamic allocation of workloads, for example, by testing servers with synthetic workloads and deploying full workloads to the server or the servers most similar to those that handled the test well. This approach yields more intelligent deployment than simply assigning workloads to the first available server.

The present technology may utilize one or more daemons running on servers in the data center to observe system data paths utilized under a particular workload on a particular server, constructing a simplified synthetic workload that adequately approximates the data computation patterns and traffic patterns of the particular workload. Servers can also run test workloads to enable the present technology to compare how different servers perform on the particular workload.

The present technology may further compare the performance of servers running synthetic workloads against those running actual workloads. When a server running a synthetic workload performs better than the server running the actual workload, workloads can be reallocated. The results of running the synthetic workloads on the various servers may be published, for example, to the orchestrator service that may further publish a suggestion that a selected server of the plurality of servers be an executor of a workload associated with the synthetic workload based on one or more workload performance profiles.

In some cases, the orchestration service manages workloads in a data center by receiving performance profiles from multiple servers executing synthetic workloads. The orchestration service may monitor server performance and determine a subset of preferred servers to execute specific workloads based on workload performance profiles. A server may be selected based on having a preferred workload performance profile. Workload performance profiles may include numeric metrics such as throughput, response time, and latency rates, as well as key performance indicators (KPIs) like transaction per second (TPS), average response time, and error rates.

In some cases, the orchestration service may assign priority metrics to respective workloads of respective servers, allowing for the execution of high-priority workloads on available servers despite lower performance metrics. The preferred workload performance profile may be determined based on a comparison of workload performance data across multiple servers. The orchestration service may further monitor synthetic workload performance across multiple servers and moves an associated workload to a first server that meets performance thresholds.

Within the data center, the orchestrator service may periodically check for underperforming servers and execute a synthetic workload to determine if it is a better fit as an executor for the respective workload. In some cases, a model correlating personality-to-workload strength test efficiency may be generated over time, allowing subsequent workloads to be assigned to hardware whose "personalities" have higher similarities and, thus, higher confidence at excelling at a particular workload. The model considers how well a specific workload performs when executed on different servers (i.e., its strength test efficiency) and compares this to the characteristics of each server (its personality vector). The workload strength test efficiency is being correlated with a server's "personality" (characteristics and performance profiles). This allows the orchestrator service to assign workloads to servers that are likely to perform well on them based on their similarities in characteristics and past performance.

Servers may be represented by "personality vectors" (e.g., weighted n-dimensional vector representations of various server characteristics). Server characteristics may include, among other things, server configurations, current server workloads, environmental conditions, resource utilization data, and workload performance profiles. Data from the workload test, presented as workload performance profiles, may be cross-referenced against personality vectors to find servers with similar personality vectors as those with higher performance metrics.

Such an approach may provide for more accurate matching of workloads with suitable servers when a new instance of a workload needs to be instantiated. As such, not every server that could be a potential match needs to have executed the synthetic workload. For example, while graphics processing units (GPUs) are often employed to accelerate machine-learning computations, there are scenarios where a central processing unit (CPU) might be more suitable due to the relatively small size of the workload. Cross-referencing using personality vectors tailored to a specific test workload can also help uncover lesser-known server configurations optimized for processing similar workloads. The "personality vectors" may account for inter-dependencies between various server characteristics, and may recommend a server that may not be an obvious choice based on comparing only one server metric.

As such, there is a need in the art for discovery of a best-fit server to work on outstanding workloads in a data center, especially if the hardware in a data center can self-discover what sorts of workloads it would excel at, and take over the workloads from less-apt hardware, freeing them up to find workloads for which they would be a stronger executor.

The present technology addresses current problems in the art by providing a more efficient workload allocation to suitable resources within a data center, considering the transient nature of both workload requirements and available resources. The technical advantages achieved by this improvement include at least improved resource utilization, reduced latency, and enhanced system reliability. By leveraging machine learning-based workload profiling and server characterization, the present technology can accurately predict which servers are best suited to execute specific workloads, minimizing the overhead of re-allocating workloads and reducing the likelihood of performance bottlenecks.

Furthermore, by matching workloads with suitable servers, organizations can minimize the waste of computing resources and optimize their data center infrastructure. In addition, with the ability to predict which servers will perform best on specific workloads, applications can respond more quickly to user requests, improving overall system responsiveness. And by dynamically re-allocating workloads to available servers that meet performance thresholds, organizations can reduce the likelihood of system failures and improve overall data center uptime.

The present technology also addresses current problems in the art by enabling the orchestration service to monitor server performance, determine preferred servers for specific workloads based on workload performance profiles, and dynamically move associated workloads to first servers that meet performance thresholds, thereby improving the overall efficiency and effectiveness of workload allocation within a data center.

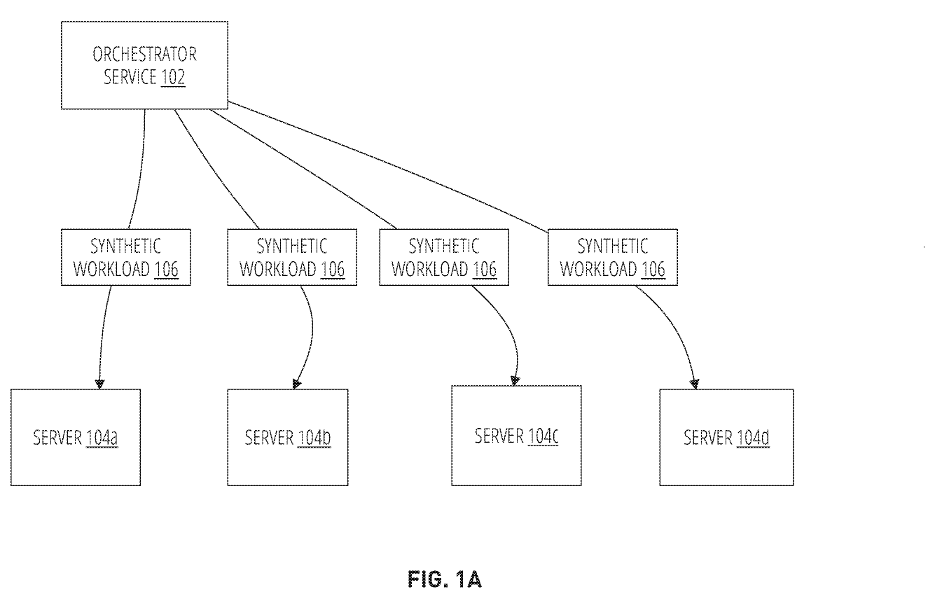

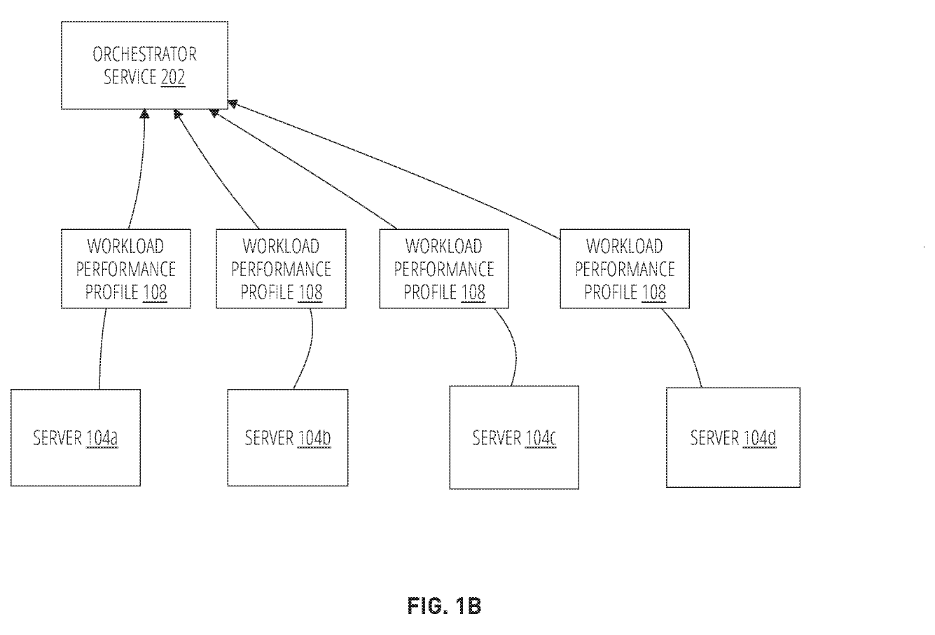

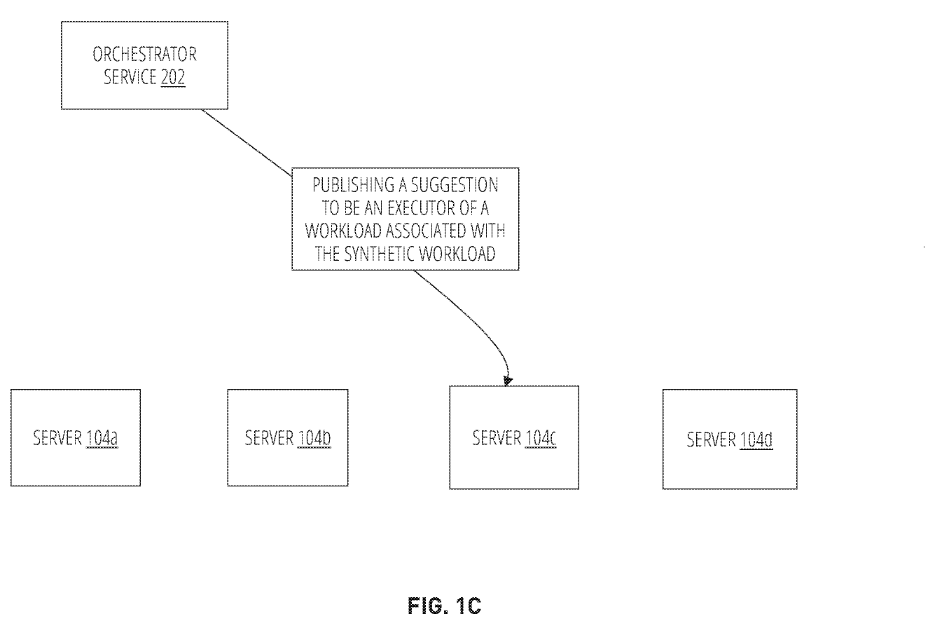

FIGS. 1A-1C illustrate an example environment for selecting a server for executing one or more workloads based on executing a synthetic workload in accordance with some aspects of the present technology.

As shown in FIG. 1A, an orchestrator service 102, which may be located on an orchestrator or a server that is deemed to be a leader of a plurality of servers, may distribute a synthetic workload 106 to servers 104 (i.e., server 104a, server 104b, server 104c, server 104d), which may be one or more servers. In some cases, the orchestrator service 102 may monitor the servers 104 that are executing the synthetic workload 106. As shown in FIG. 1B, the orchestrator service 102 may receive the workload performance profiles 108 associated with the execution of the synthetic workload on the servers 104. As shown in FIG. 1C, a suggestion may be published for a selected server of the servers 104 to be an executor of a workload associated with the synthetic workload 106.

In some cases, a subset (e.g., one or more) of the servers 104 may be identified as having the preferred performance profile for executing the synthetic workload 106 based on the performance profiles of the servers 108. In some cases, the synthetic workload 106 may be created based on characteristics of an actual workload. In some cases, the synthetic workload 106 approximates at least a portion of the actual workload. The synthetic workload may adequately approximate the data computation patterns of the workload, traffic patterns of the workload, memory/storage requirements of the workload, and/or other characteristics of the workload. In some cases, the system may generate synthetic workloads that represent various types of workloads. For example, a batch processing workload may include high memory requirements and low traffic patterns. A real-time analytics workload may include high data computation demands and fast response times. A web-based application workload may include varying traffic patterns and storage requirements. The synthetic workload 106 may be created to mimic the characteristics of these different types of workloads. By doing so, the system can netter identify which servers are most suitable for executing specific workloads, optimize resource allocation and utilization across the data center, and improve overall system reliability and performance.

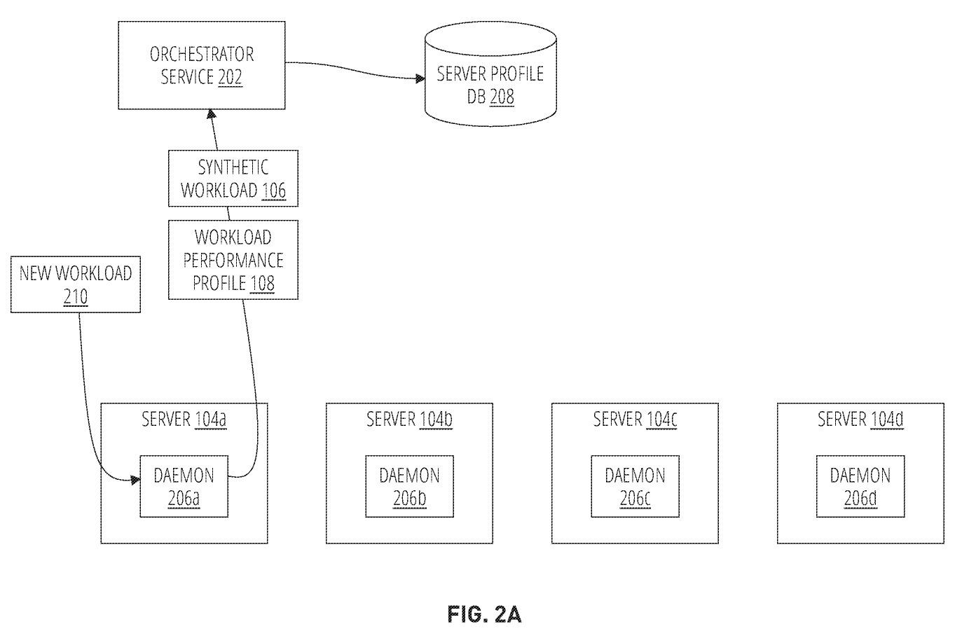

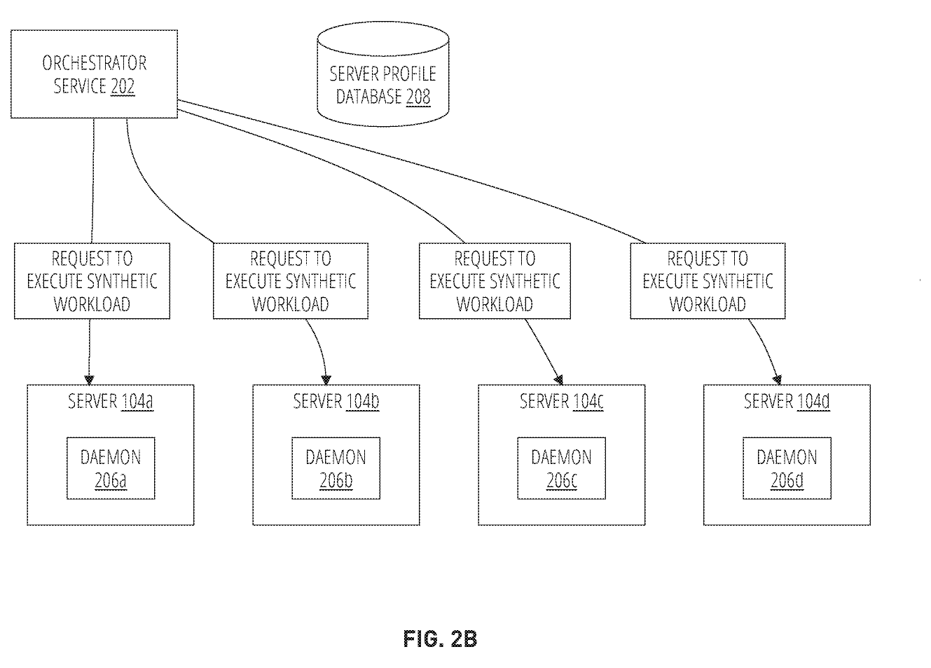

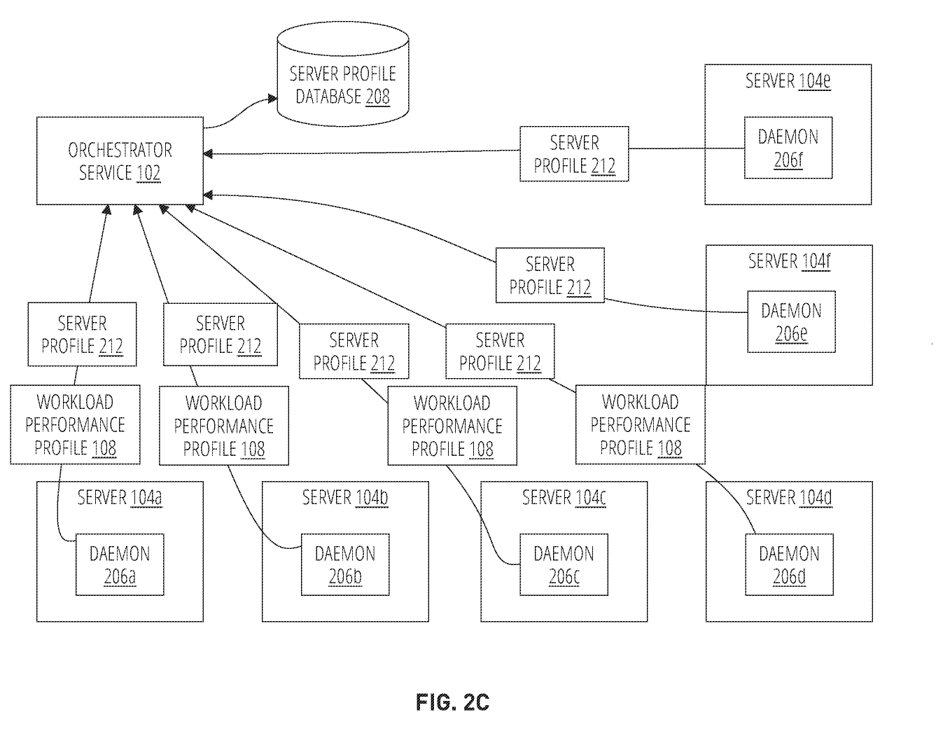

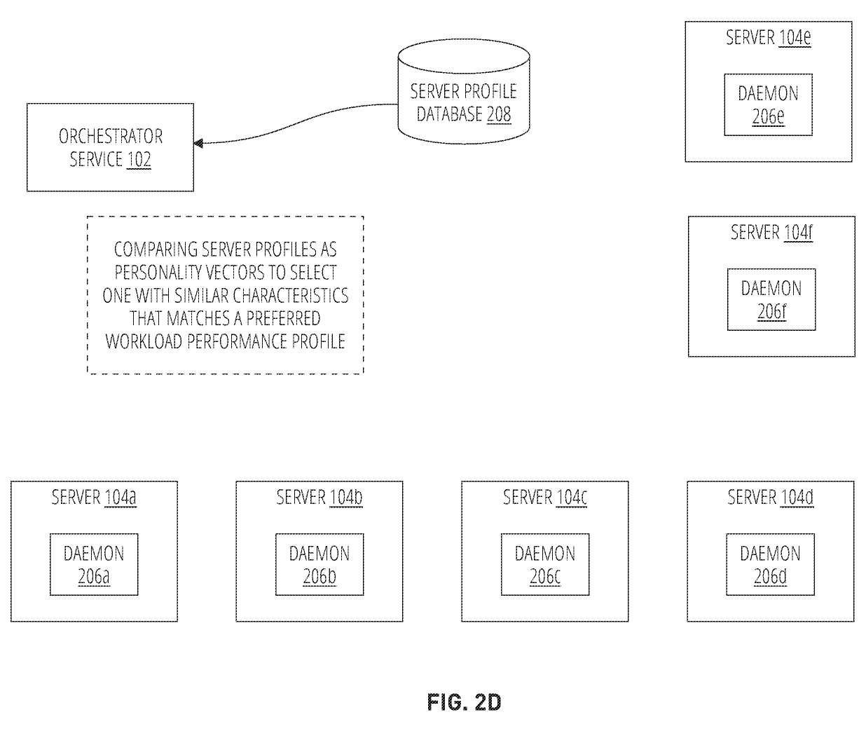

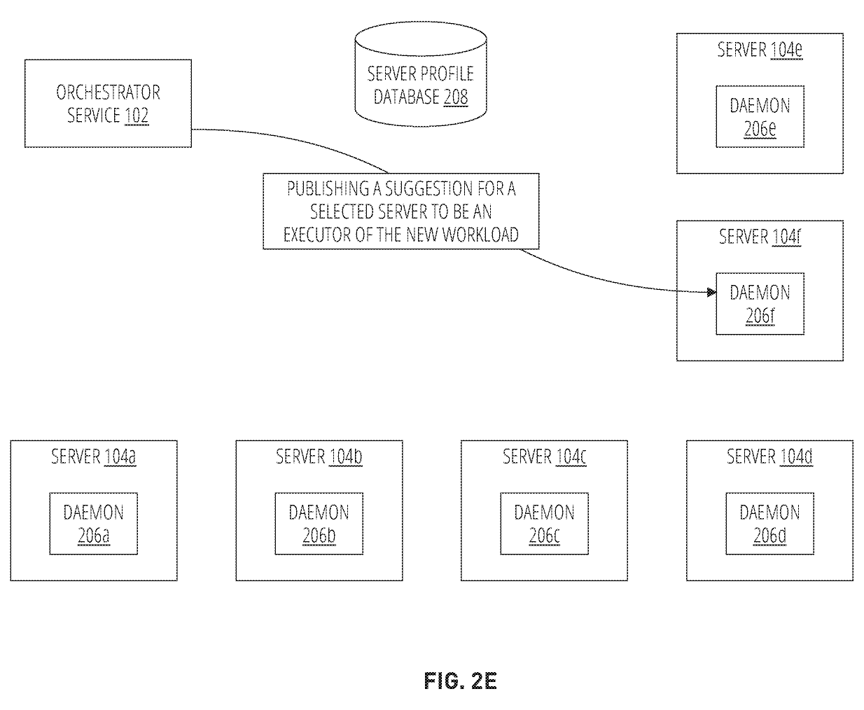

FIG. 2A illustrates an example environment for selecting a server for executing one or more workloads based on executing a distributed synthetic workload in accordance with some aspects of the present technology.

In some cases, a first server 204a, which may be one of a plurality of servers 104, may receive a new workload 210. In some cases, the synthetic workload may be generated by the first server 204a. The synthetic workload may be generated based on self-observing data flows on the first server.

The efficiency with which the first server 204a executes the new workload 210 may vary based on factors such as the server's processing capabilities, resource availability, and software configuration. A daemon 206 that is running on the first server 204a may characterize the new workload 210 and report on the performance of the first server 204a that is running the new workload 210 to the orchestrator service 102. The plurality of servers 104 may be monitored by one or more daemons 206.

In some cases, the daemon 206 of the first server 204a may generate the synthetic workload 106 based on the new workload 210 that approximates at least a portion of the new workload 210 based on the characterization of the new workload 210. In some cases, the daemon 206 observes system data paths utilized under a current workload and constructs a simplified synthetic workload that adequately approximates the data computation patterns and traffic patterns of the workload. In other cases, the orchestrator service 102 may generate the synthetic workload 106 based on received characterizations of the new workload 210.

Additionally, the orchestrator service 102 may also receive a report on the performance of the first server 204a in executing the new workload 210. The report may be in the form of a workload performance profile 108 that represents the performance characteristics of the first server 204a. The workload performance profile 108 serves as a baseline for comparison, enabling the identification of servers 104 that demonstrate improved performance when executing the synthetic workload 106 compared to the first server 204a. In some cases, the first server 204a may not have executed the new workload 210 yet, and may execute the synthetic workload 106, which is either generated by the first daemon 206 or received from the orchestrator service 102, to generate the workload performance profile 108. In other cases, the first server 204a may not execute the new workload 210 or the synthetic workload 106 because it already has been determined that the first server 204a is not the best fit to execute the new workload 210.

In some cases, the orchestrator service 102 may be a leader daemon 206 of the one or more daemons 206 or a cluster of the one or more daemons 206. In some cases, the orchestrator service 102 may receive workload updates associated with the new workload or a changed or updated workload. The daemon, such as the first daemon 206, may automatically self-activate to send the synthetic workload or new characteristics for the workload updates.

FIG. 2B illustrates the example environment of FIG. 2A for selecting a server for executing one or more workloads based on how a server executed a synthetic workload in accordance with some aspects of the present technology.

In some cases, the orchestrator service 102 may send a request to execute the synthetic workload 106 by instructing one or more servers or daemons of the one or more servers to generate and execute the synthetic workload 106 or by directly sending the synthetic workload 106 to the one or more daemons. In some cases, the orchestrator service 102 may not provide guidance or instruction on how to generate and execute the workload. In other cases, the synthetic workload 106 could get sent directly to a server or daemon for execution. For example, the orchestrator service 102 may have prepared and pre-configured the synthetic workload 106 in a format suitable for direct execution.

In some cases, the orchestrator service 102 may send characteristics of the new workload 210 to the respective daemons 206 of the servers 104. The daemons 206 may then generate and execute at least a portion of the workload in the form of the synthetic workload 106. In some cases, the orchestrator service 102 may request the daemons 206 to run the synthetic workload by providing them with one of the following: a description of the new workload 210, which allows the daemon to generate and execute a suitable portion of the workload in the form of the synthetic workload 106; a description of the synthetic workload 106 itself, which enables the daemon to directly run it; or a small sample or portion of the new workload 210, which the daemon can use as a reference to generate and execute the remainder of the workload as the synthetic workload 106.

FIG. 2C illustrates the example environment of FIG. 2A for selecting a server for executing one or more workloads based on how a server executed a synthetic workload in FIG. 2B in accordance with some aspects of the present technology.

Once the servers 104 have executed the synthetic workload 106 or some variation thereof, the servers 104 or the respective daemons 206 may report back to the orchestrator service 102 with the workload performance profiles 108 generated based on the server’s execution of the synthetic workload.

Additionally, the orchestrator service 102 may receive server profiles from the servers 104 or the respective daemons 206. The server profiles 212 may represent characteristics of one or more respective servers 104, including for example, hardware specifications, server location, environmental characteristics such as local network health external to the server, external or internal temperature data, or utilization data. In some cases, the server profiles 212 are represented by personality vectors.

After receiving the workload performance profile 108 from the servers 104, the orchestrator service 102 may compare workload performance profile 108 from the first server 204a with other received workload performance profiles 108. After comparing, the orchestrator service 102 may determine that there are one or more preferred workload performance profiles 108 that performed better than the baseline workload efficiency of the workload performance profile 108 from the first server 204a. In some cases, one of the servers 104 associated with the one or more preferred workload performance profiles 108 may be selected to be the executor of the workload.

However, in some cases, the servers 104 associated with one or more preferred workload performance profiles 108 may not be available. In such a case, there may be other servers (i.e., servers 104e, 104f) of the servers 104 that did not execute the synthetic workload 106 that could be candidates. In some cases, those other servers may also provide server profiles 212 to the orchestrator service 102, and those server profiles 212 may also be represented as other personality vectors.

In some cases, the orchestrator service 102 may compare a number of the other personality vectors with the personality vectors that represent the servers 104 associated with the one or more preferred workload performance profiles 108. Based on the comparison, the orchestrator service 102 may select one of the personality vectors that has a proximity relationship with at least one of the personality vectors that represent the servers 104 associated with the one or more preferred workload performance profiles 108.

The proximity relationship may be determined by a vector comparison algorithm such as by respective cosine similarity values. In some cases, the proximity relationship may be calculated based on a threshold value, which may be predetermined, determined dynamically, or discovered over the course of aggregating information returned by regularly-occurring synthetic benchmarks. For example, the servers 104 associated with the one or more preferred workload performance profiles 108 may not be available for execution of the new workload. In some cases, there may be other servers that have a proximate relationship to the particular server based on the respective personality vectors that may not have executed the synthetic workload and may not be an obvious choice purely based on one or two characteristics.

In some cases, the orchestrator service 102 may monitor server characteristics, such as server configurations, current server workloads, environmental conditions, resource utilization data, and workload performance profile of the one or more respective servers. The orchestrator service 102 may also determine the personality vectors of the one or more respective servers based on the monitored server characteristics. The determined subset may include determining one or more personality vectors that represent the one or more preferred workload performance profile.

The process of comparing personality vectors of servers may involve leveraging techniques from linear algebra and machine learning to identify similarities between servers based on their characteristics. With each server represented as a vector in a n-dimensional space, where each dimension corresponds to a specific characteristic (e.g., CPU utilization, memory usage, disk I/O rates), the weights associated with each dimension may be determined by the relative importance of that characteristic for the given workload or scenario.

The vector-based approach can also account for the specific characteristics of servers. For example, servers with high read/write ratios may be favored for sequential writes, while servers with low read/write ratios may be favored for random reads. Similarly, if a server's vector indicates it has a high percentage of small file operations, the orchestrator service 102 may select such types of servers that are well-suited to handle such workloads, ensuring optimal performance and minimizing the risk of storage-related issues. By considering these factors when directing workloads, the orchestrator service 102 can take a more holistic approach to system management, one that balances performance with reliability and longevity.

The vectors may be compared using cosine similarity to determine the proximity relationship between the servers. The cosine similarity value between two vectors may be calculated, for example, as the dot product of the two vectors divided by the product of their magnitudes. A threshold value, or a cosine threshold, may be predetermined or dynamically determined to establish a cutoff for what constitutes a "similar" server profile. When comparing another server vector against a preferred server profile vector, the cosine similarity value may be calculated and compared against the threshold value. If the similarity value exceeds the threshold value, then the other server vector may be considered "similar" to the preferred server profile vector. Such an approach may provide a flexible and scalable means of evaluating server profiles in high-dimensional spaces.

Some alternative methods for determining proximity relationships between servers that result in a similar outcome may include calculating a Euclidean distance that is based on a calculation of a straight-line distance between two points (vectors) in n-dimensional space, which may be more intuitive than cosine similarity for some use cases. Correlation coefficients may be used to quantify a strength and direction of linear relationships between two variables, which may be applied to vector comparisons in a similar manner. These methods share similarities with cosine similarity in that they all aim to quantify the proximity relationship between server profiles, but may differ in their mathematical formulation and interpretability. There may be other alternative methods that are not mentioned that serve a similar purpose for comparing the vectors.

In some cases, priority metrics may be assigned to respective workloads of respective servers. As such, workloads with higher priority metrics may be executed on available servers despite having lower performance metrics compared to other workloads with lower priority metrics but higher performance metrics associated with the available servers. The lower performance metrics and the higher performance metrics may be compared based on respective workload performance profile. For example, a certain workload may be assigned relatively high priority metric and, therefore, be given priority to certain servers even when those servers are better suited for the lower priority workloads.

FIG. 2D illustrates the example environment of FIG. 2A for selecting a server for executing one or more workloads based on how a server executed a synthetic workload in FIG. 2C in accordance with some aspects of the present technology.

In some cases, the orchestrator service 102 may select one of the subset of servers that has a preferred workload performance profile or another server with a personality vector that has a proximity relationship to one of the subset of servers that has a preferred workload performance profile. The orchestrator service 102 may then publish the suggestion for the selected server to become an executor of the new workload.

In some cases, refreshed calculations of the respective personality vectors may be received at a predetermined temporal cadence. The predetermined temporal cadence may be fixed or adaptive. In some cases, the predetermined temporal cadence may be determined based on the state of the plurality of servers. For example, if the plurality of servers is experiencing a heavy workload, the predetermined temporal cadence may be increased. For example, the cadence may be increased because there are more frequent changes to the server availabilities and utility. As another example, the cadence may be decreased to reduce computational load.

The multiple temporally-separated calculations may be aggregated to produce a smoothed vector representation that represents a filtered set of the respective personality vectors. The one or more personality vectors may be based on the aggregated calculations. In some cases, one personality vector at one point in time may not accurately depict what the state of the respective server is. However, taking a smoothed vector representation that is based on multiple temporally-separated calculations may be a better way of capturing the state. For example, one server may have just finished a workload and is queuing up another workload. If the personality vector captures the point in time where the server is in between workloads, the personality vector may inaccurately portray the typical characteristics of the server.

If there are any updates to the workload or changes to the personality vectors that would result in a different set of servers being more preferred to execute the workload, a new synthetic workload may be distributed, and/or a changed workload performance profile may be received.

FIG. 2E illustrates the example environment of FIG. 2A for selecting a server for executing one or more workloads based on how a server executed a synthetic workload in FIG. 2D in accordance with some aspects of the present technology.

Based on the new profiles, a new subset of the respective servers may be determined to have new preferred workload performance profile associated with execution the new synthetic workload. At least some of the new preferred workload performance profile may have a better workload efficiency than at least some of the previously preferred workload performance profile.

Accordingly, the orchestrator service 102 may then publish a suggestion for a new selected server to become an executor of the new workload 210. As such, a server 104 that did not execute the new synthetic workload may be determined to be a best fit based on comparing the personality vectors. By requiring fewer servers 104 to execute synthetic workloads, the system experiences an alleviation of resource strain. This optimization not only decreases operational demands but also enhances overall efficiency and performance.

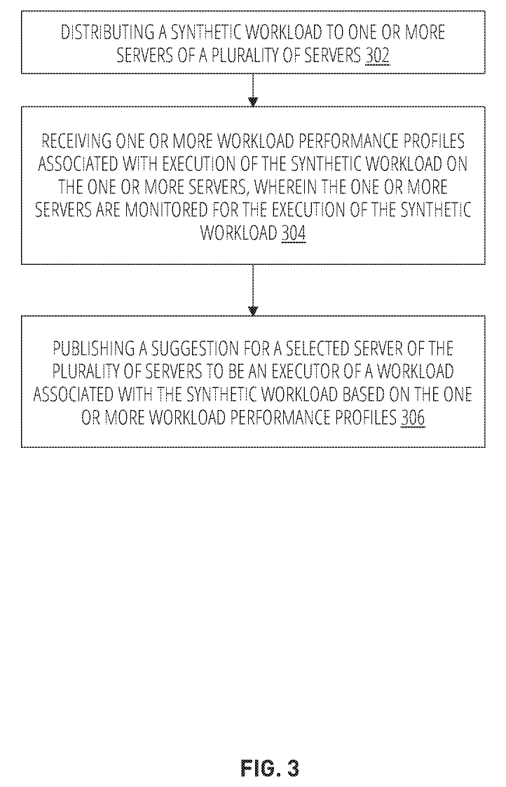

FIG. 3 illustrates an example method for publishing a suggestion for a selected server to be an executor of a workload associated with a synthetic workload based on workload performance profiles in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes distributing a synthetic workload to one or more servers of a plurality of servers at step 302. The orchestrator service 102 may distribute the synthetic workload. According to some examples, the method includes receiving one or more workload performance profiles associated with execution of the synthetic workload on the one or more servers at step 304. In some cases, the one or more servers are monitored for the execution of the synthetic workload. The execution of the synthetic workload may be monitored by each individual server or the orchestrator service 102.

According to some examples, the method includes publishing a suggestion for a selected server of the plurality of servers to be an executor of a workload associated with the synthetic workload based on the one or more workload performance profiles at step 306. Publishing the suggestion for the selected server to execute the workload typically involves the server receiving and processing the suggestion, which is often a batch of tasks or computations. The server may then execute the workload on its own resources (CPU, memory, etc.) while maintaining communication with the orchestrator server 102 to confirm that the server is the executor of the workload.

In some cases, rather than directing workloads to servers based on their ability to handle the expected load, other factors that influence the overall health and longevity of a server or storage system may be taken into consideration as well. For instance, storage (write) workloads can be steered towards servers or hard drives with lower cycle counts, even if they're performing well, to prevent premature wear and tear. This proactive approach ensures data is stored on systems with sufficient "headroom" for future growth, reducing the likelihood of costly hardware failures.

In some cases, the synthetic workload may not be necessary for a sophisticated approach involving selecting servers based on their vector representations. For example, by analyzing how other servers with similar vectors have performed in the past, under various workloads, the orchestrator service 102 may make informed decisions about where to direct new workloads. This approach may encourage a more nuanced understanding of server performance, considering factors such as power consumption, cooling requirements, and network connectivity. For example, there may be a number of servers that are expected to perform well and one of the servers may be selected based on attributes of its vector representation, such as attributes that may affect data center planning. In such cases, the servers may not need to have executed the synthetic workload, thus reducing the overall time and energy consumption.

In addition, other factors that can influence the overall health and longevity of a server or storage system may include factors such as its thermal profile, electrical noise characteristics, and physical location within the data center. For instance, servers located in areas with high temperatures or humidity may be more prone to overheating, which can reduce their lifespan. Similarly, servers that generate significant electrical noise may interfere with other systems in the data center, leading to performance issues and potentially even hardware failures. By considering these factors when directing workloads, operators can take a proactive approach to ensuring system reliability and longevity, without the need for the servers to have executed a synthetic workload.

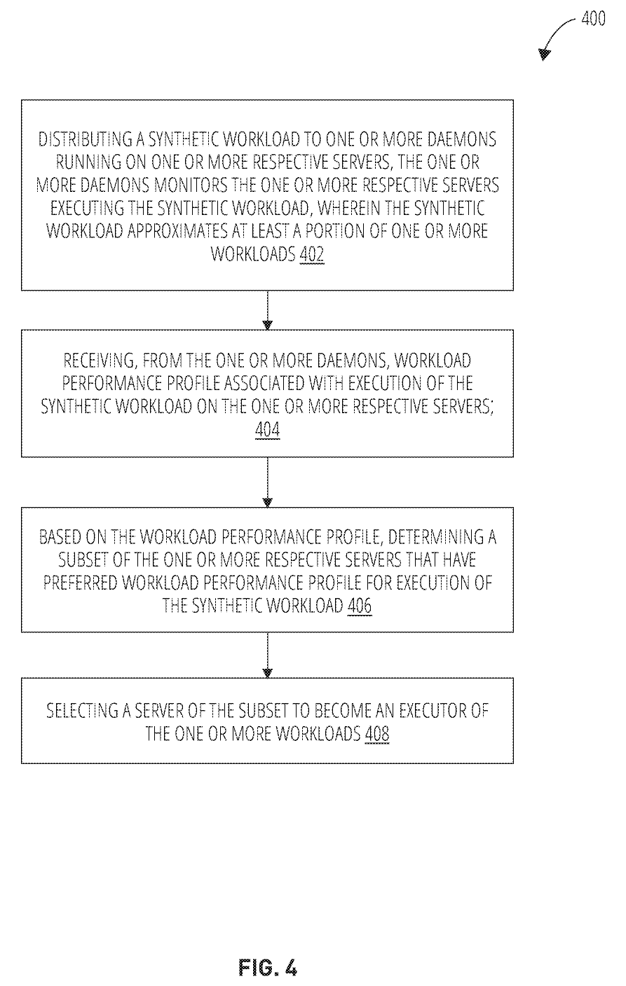

FIG. 4 illustrates an example method 400 for selecting a server for executing one or more workloads based on performances of executing a distributed synthetic workload in accordance with some aspects of the present technology. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes distributing a synthetic workload to one or more daemons running on one or more respective servers, the one or more daemons monitor the one or more respective servers executing the synthetic workload, wherein the synthetic workload approximates at least a portion of one or more workloads at step 402. In some cases, an orchestrator service 102 may distribute the synthetic workload 106. In some cases, the method may include creating the synthetic workload based on characteristics of the workload.

In some cases, the orchestrator service 102 may be controlled by a leader daemon or by a separate orchestrator. The leader daemon may have been chosen as a local leader for a cluster of the one or more servers. In some cases, the synthetic workload 106 may be distributed to one or more daemons running on the one or more servers. The one or more workload performance profiles may be received from the one or more daemons.

The method may include monitoring the one or more servers executing the synthetic workload. In some cases, the method may include determining a subset of the one or more servers that have one or more preferred workload performance profiles for execution of the synthetic workload based on the workload performance profiles. The server may be selected based on the one or more preferred workload performance profiles. For example, the workload performance profiles may include numeric metrics such as throughput, response time, and latency rates, which measure how efficiently each server processes the synthetic workload. Additionally, key performance indicators (KPIs) like transaction per second (TPS), average response time, and error rates are also used to provide a data-driven comparison of the servers' ability to handle the workload, allowing for a quantitative assessment of their performance.

In some cases, the orchestrator service 102 may receive a first workload performance profile from a first server that executed the at least a portion of the workload, wherein the first workload performance profile indicates a baseline workload efficiency of the execution of the workload. In some cases, the orchestrator service 102 may further compare the first workload performance profile with other received workload performance profiles associated with the execution of the workload by other servers to determine a preferred workload performance profile of a respective server that performs better than the baseline workload efficiency.

According to some examples, the method includes receiving, from the one or more daemons, workload performance profiles associated with the execution of the synthetic workload on the one or more respective servers at step 404. In some cases, the orchestrator service 102 may receive the workload performance profiles.

In some cases, the method includes assigning priority metrics to respective workloads of respective servers. Workloads with higher priority metrics may be executed on available servers despite having lower performance metrics compared to other workloads with lower priority metrics but higher performance metrics associated with the available servers. The lower performance metrics and the higher performance metrics may be compared based on respective workload performance data.

According to some examples, the method includes, based on the workload performance profile, determining a subset of the one or more respective servers that have a preferred workload performance profile for execution of the synthetic workload at step 406. According to some examples, the method includes further selecting a server of the subset to become an executor of the one or more workloads at step 408.

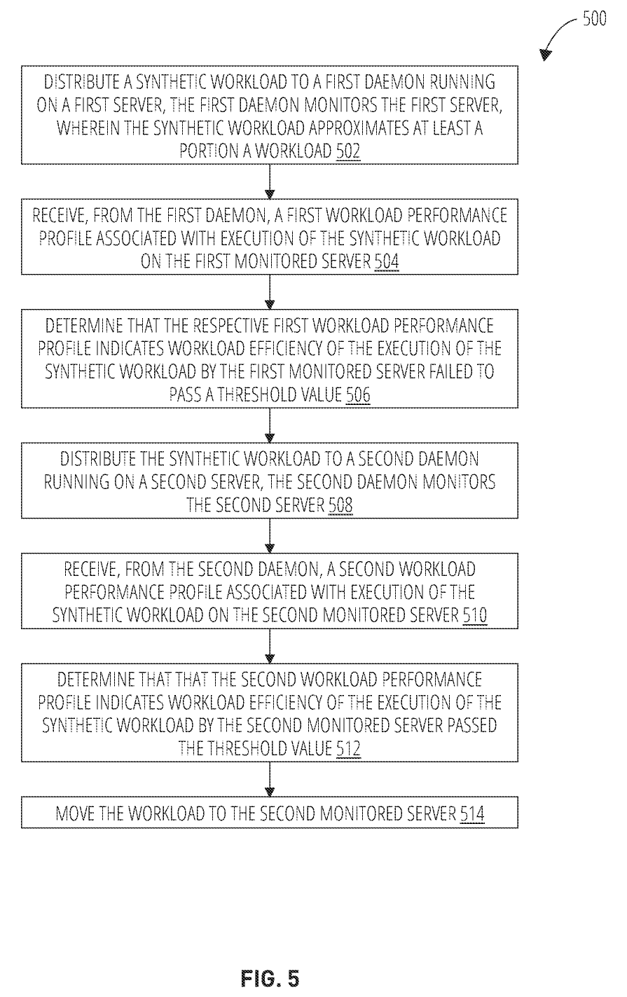

FIG. 5 illustrates an example method 500 for deploying a workload in a data center that involves monitoring synthetic workload performance across multiple servers, and moving an associated workload to a first server that meets performance thresholds. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method includes distributing a synthetic workload to a first daemon running on a first server at step 502. In some cases, the first daemon monitors the first server, and the synthetic workload approximates at least a portion a workload. In some cases, the orchestrator service 102 may distribute the synthetic workload. The orchestrator service 102 may be located on an orchestrator or a server that is deemed to be a leader of a plurality of servers.

According to some examples, the method includes receiving, from the first daemon, a first workload performance profile associated with execution of the synthetic workload on the first monitored server at step 504. The orchestrator service 102 may receive the first workload performance profile. The first workload performance profile may represent performance characteristics of the first monitored server. According to some examples, the method includes determining that the respective first workload performance profile indicates workload efficiency of the execution of the synthetic workload by the first monitored server failed to pass a threshold value at step 506. In some cases, the orchestrator service 102 may send the synthetic workload 106 one at a time and when the first monitored server failed to pass the threshold value, the orchestrator service 102 may try another server.

As such, according to some examples, the method includes distributing the synthetic workload to a second daemon running on a second server at step 508. The second daemon may monitor the second server. According to some examples, the method includes receiving, from the second daemon, a second workload performance profile associated with execution of the synthetic workload on the second monitored server at step 510. According to some examples, the method includes determining that that the second workload performance profile indicates workload efficiency of the execution of the synthetic workload by the second monitored server passed the threshold value at step 512, and the orchestrator service 102 may move the workload to the second monitored server at step 514. In some cases, the method may include receiving server profiles from a plurality of servers. The server profiles may represent characteristics of the plurality of servers. The characteristics may include hardware specifications, temperature data, or utilization data. The method may further include determining personality vectors of the plurality of servers including the first server and the second server. The server profiles may be represented as the personality vectors. In some cases, the move of the workload may be based on a comparison of at least some of the personality vectors.

In some cases, a request to prioritize an optimization parameter associated with a plurality of servers may be received. The plurality of servers includes the first server and the second server. The optimization parameter associated with the first workload efficiency and the second workload efficiency may be compared. For example, the optimization parameter may be for execution of speed or job execution price, or job execution carbon consumption. The move may also consider the comparison and only move to the second server if the comparison of the optimization parameter is favorable.

In some cases, a request to modify the optimization parameter may be received. Based on the modification, the synthetic workload may be sent to a third server so that the optimization parameter may be further optimized.

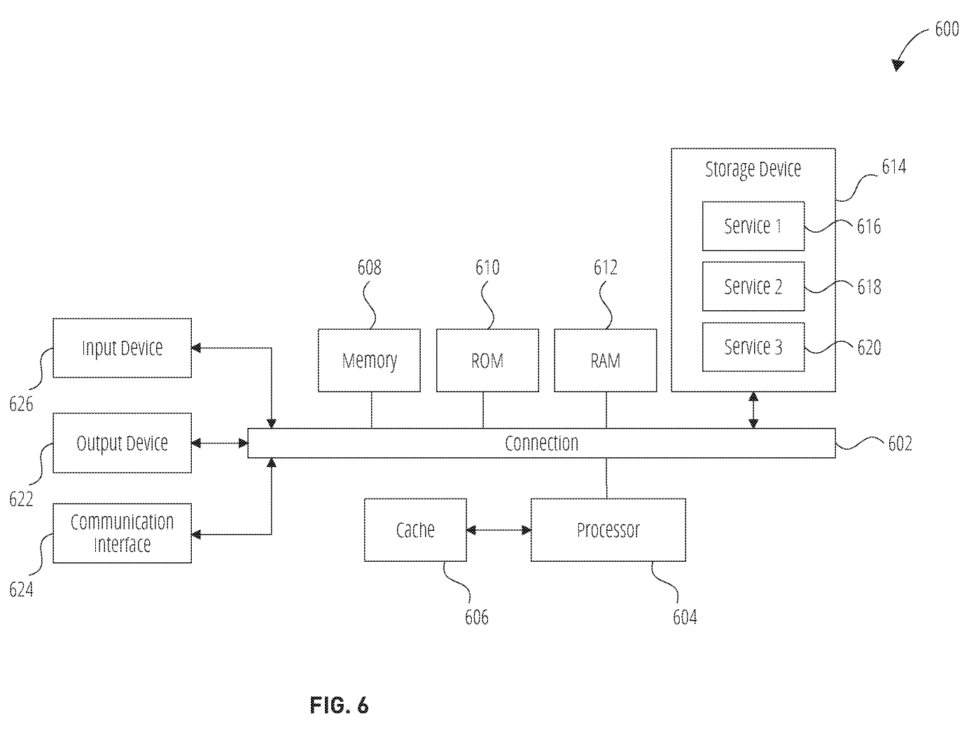

FIG. 6 shows an example of computing system 600, which can be for example any computing device making up servers 104 or other computing devices that the orchestrator service 102 resides on, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 6088, such as read-only memory (ROM) 610 and random access memory (RAM) 612 to processor 604. Computing system 600 can include a cache of high-speed memory 608 connected directly with, in close proximity to, or integrated as part of processor 604.

Processor 604 can include any general purpose processor and a hardware service or software service, such as services 606, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a computing device and/or one or more servers and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
distributing a synthetic workload to one or more servers of a plurality of servers;
receiving one or more workload performance profiles associated with execution of the synthetic workload on the one or more servers, wherein the one or more servers are monitored for the execution of the synthetic workload; and
publishing a suggestion for a selected server of the plurality of servers to be an executor of a workload associated with the synthetic workload based on the one or more workload performance profiles.

2. The computer-implemented method of claim 1, further comprising:
receiving, by an orchestrator service, a first workload performance profile from a first server that executed the at least a portion of the workload, wherein the first workload performance profile indicates a baseline workload efficiency of the execution of the workload.

3. The computer-implemented method of claim 2, further comprising:
comparing the first workload performance profile with other received workload performance profiles associated with execution of the workload by other servers to determine a preferred workload performance profile of a respective server that performs better than the baseline workload efficiency.

4. The computer-implemented method of claim 1, further comprising:
receiving server profiles from the one or more servers, the server profiles representing characteristics of the one or more servers, wherein the server profiles are represented as personality vectors; and
determining one or more personality vectors that are similar to a first server profile for a server that is associated with one or more preferred workload performance profiles.

5. The computer-implemented method of claim 4, further comprising:
comparing the personality vectors with other personality vectors that represent other servers of the one or more servers; and
selecting one of the other personality vectors that has a proximity relationship with at least one of the one or more personality vectors, wherein the proximity relationship is determined by a vector comparison algorithm, wherein the selected server is represented by the selected other personality vector.

6. The computer-implemented method of claim 5, further comprising:
determining that respective servers associated with the one or more personality vectors are not available, wherein the selecting the other personality vectors is based on the determination that servers associated with the one or more personality vectors are not available.

7. The computer-implemented method of claim 4, further comprising:
receiving refreshed calculations of respective personality vectors at a predetermined temporal cadence; and
aggregating the refreshed calculations to produce a filtered set of the respective personality vectors, wherein the one or more personality vectors are based on the aggregated calculations.

8. The computer-implemented method of claim 7, wherein the aggregated calculations are temporally-separated calculations that produce a smoothed vector representation represented by the filtered set of the respective personality vectors.

9. The computer-implemented method of claim 2, wherein the synthetic workload is generated by the first server, wherein the generated synthetic workload is based on self-observing data flows on the first server.

10. A non-transitory computer-readable storage medium, the computer-readable storage medium including instructions that when executed by a computing system, cause the computing system to:
instruct a first server to execute a synthetic workload, wherein the synthetic workload approximates at least a portion a workload;
receive, a first workload performance profile associated with execution of the synthetic workload on the first server;
determine, based on the first workload performance profile, a first workload efficiency of the execution of the synthetic workload by the first server;
instruct a second server to execute the synthetic workload;
receive a second workload performance profile associated with execution of the synthetic workload on the second server;
determine, based on the second workload performance profile, a second workload efficiency of the execution of the synthetic workload by the second server; and
based on a comparison between the first workload efficiency and the second workload efficiency, move the workload to the second server.

11. The non-transitory computer-readable storage medium of claim 10, wherein the instructions further cause the computing system to:
receive server profiles from a plurality of servers, the server profiles represent characteristics of the plurality of servers; and
determine personality vectors of the plurality of servers including the first server and the second server, wherein the server profiles are represented as the personality vectors, wherein the move of the workload is based on a comparison of at least some of the personality vectors.

12. The non-transitory computer-readable storage medium of claim 10, wherein the instructing the first server includes instructing a first daemon running on the first server, wherein the first daemon monitors the first server, and wherein instructing the second server includes instructing a second daemon running on the second server, and wherein the second daemon monitors the second server.

13. The non-transitory computer-readable storage medium of claim 10, wherein the instructions further cause the computing system to:
generate the synthetic workload based on received characteristics of the workload.

14. The non-transitory computer-readable storage medium of claim 10, wherein the instructions further cause the computing system to:
receive a request to prioritize an optimization parameter associated with a plurality of servers, wherein the plurality of servers includes the first server and the second server; and
compare the optimization parameter associated with the first workload efficiency and the second workload efficiency, wherein the move is also based on the comparison.

15. The non-transitory computer-readable storage medium of claim 14, wherein the instructions further cause the computing system to:
receive a request to modify the optimization parameter;
based on the modification, send the synthetic workload to a third server.

16. The non-transitory computer-readable storage medium of claim 10, wherein the instructions further cause the computing system to:
assign priority metrics to respective workloads of respective servers, wherein workloads with higher priority metrics are executed on available servers despite having lower performance metrics compared to other workloads with lower priority metrics but higher performance metrics associated with the available servers, wherein the lower performance metrics and the higher performance metrics are compared based on respective workload performance data.

17. A system comprising:
one or more processors; and
a memory storing instructions that, when executed by the one or more processors, cause the system to:
distribute a synthetic workload to a first server, wherein the synthetic workload approximates at least a portion a workload;
receive, from the first server, a first workload performance profile associated with execution of the synthetic workload on the first server;
distribute the synthetic workload to a second server;
receive, from the second server, a second workload performance profile associated with execution of the synthetic workload on the second server; and
based at least on the first workload performance profile and the second workload performance profile, assign the workload to the second server.

18. The system of claim 17, wherein the instructions further cause the system to:
receive workload updates associated with a new workload or a changed workload, wherein the second server automatically self-activates to send a new synthetic workload or new characteristics for the workload updates to one or more other servers.

19. The system of claim 18, wherein the instructions further cause the system to:
based on the workload updates, distribute the new synthetic workload to the one or more other servers;
receive, from the one or more servers, respective new workload performance profiles associated with execution of the new synthetic workload on the one or more other servers; and
based on the new workload performance profiles, determine a new subset of the one or more other servers have one or more new preferred workload performance profiles associated with execution the new synthetic workload.

20. The system of claim 19, wherein the instructions further cause the system to:
publish a new suggestion for a new server of the new subset to become an executor of the new workload.
